(19) United States
(12) Patent Application Publication
(10) Pub. No.: US 2002/0007804 A1
(43) Pub. Date: Jan. 24, 2002

(54) Fuel additive controlling and maintaining apparatus

(76) Inventors: Clyde LeRoy Tichenor, Somis, CA (US); Irwin Ginsburgh, Castaic, CA (US); Darrell J. Metcalf, Fillmore, CA (US)

Correspondence Address: ALBERT O COTA, 5460 WHITE OAK AVE, SUITE A-331, ENCINO, CA, 91316, US

(21) Appl. No.: 09/907,567

(22) Filed: Jul. 18, 2001

Related U.S. Application Data
(60) Provisional application No. 60/219,260, filed on Jul. 18, 2000.

(51) Int. Cl. F02M 25/00

(52) U.S. Cl. 123/1 A; 180/69.4

(57) ABSTRACT

A fuel additive controlling and maintaining apparatus used to eliminate the loss of absorbed CO₂ gas mixed into liquid hydrocarbon fuel and particularly diesel fuel. In addition to the gas-enriched fuel, a gastight bag is utilized for holding a stabilizing gas mixture of CO₂ and air that is not absorbed in the fuel. This bag, which is located within a protective enclosure and is connected into the ullage of a fuel tank, via a conduit, has approximately the same volume as the fuel tank. A two product refueling means is provided so that gas-enriched fuel is delivered to the fuel tank and the CO₂ gas is delivered to the gastight bag. During fuel usage, as the fuel tank ullage increases, the gas mixture from the gastight bag maintains the ullage in a substantially filled condition thus, allowing the fuel to remain gas-enriched.

### TECHNICAL FIELD

The invention pertains to the general field of engine fuel additives and more particularly to an apparatus that allows an engine fuel to be enriched with a controllable concentration of carbon dioxide to aid in reducing engine exhaust soot.

### BACKGROUND ART

At normal temperature, hydrocarbon fuels, such as diesel fuel, absorb about one volume of gaseous carbon dioxide in an equal volume of the diesel fuel. If the gas-enriched fuel is loaded into a fuel tank in the normal manner, some of the gas will desorb due to liquid turbulence, splashing, fuel heating and fuel usage. Removing fuel from the tank can either cause ullage gas replacement by intake air or desorbed CO₂ from within the fuel. When such desorption of CO₂ from the fuel occurs, the fuel may not retain enough absorbed gas for useful purposes. The gas-retaining apparatus described herein, eliminates the loss of absorbed CO₂ gas by the diesel fuel during normal fuel usage.

A search of the prior art did not disclose any patents that read directly on the claims of the instant invention.

### DISCLOSURE OF THE INVENTION

In its basic design, the fuel additive controlling and maintaining apparatus is comprised of:

At least one gastight bag containing a mixture of gas and air,

At least one vehicle fuel tank containing a gas-enriched fuel comprising a mixture of gas and a liquid hydrocarbon fuel. The vehicle fuel tank also contains an ullage, located above the gas-enriched fuel, and

A gas conduit located between the gastight bag and the ullage.

The fuel additive controlling and maintaining apparatus is designed to manage the bi-directional flow of the mixed gases between the gastight bag and the ullage. The apparatus stabilizes and maintains the concentration of the gas in the fuel during engine operation by replacing an increased fuel tank ullage with an equal amount of the mixed gases that are transferred from the gastight bag.

The gastight bag receives the mixed gases during the initial fueling and refueling operations. The mixed gases flow into the fuel tank ullage as the fuel is depleted by the engine to prevent desorption of the gases from the remaining fuel. The gastight bag is dimensioned to provide an expanded volume equal to the volume of the fuel tank, and is located above the fuel tank, within a protective enclosure.

In view of the above disclosure, the primary object of the invention is to provide an apparatus that is capable of significantly lowering the amount of soot produced by conventional hydrocarbon engines.

It is also an object of the invention to provide an apparatus that:

can lower fuel consumption and increase mileage in a vehicle, lowers the amount of engine exhaust emissions that are released into the air,

can prolong the useful life of an engine equipped with the apparatus,

is easy to install and operate,

is low maintenance, and

is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an elevational-sectional view showing a gastight bag, located within a protective enclosure, directly connected, via a gas conduit, into the ullage of a vehicle gas tank.

FIG. 2 is an elevational-sectional view showing a gastight bag, located within a protective enclosure, with a gas conduit disconnected from the vehicle gas tank.

FIG. 3 is a graph showing the measured soot produced in a diesel engine with different concentrations of carbon dioxide in the diesel fuel.

### BEST MODE FOR CARRYING OUT THE INVENTION

The best mode for carrying out the invention is presented in terms of a preferred embodiment for a fuel additive controlling and maintaining apparatus 10 (hereinafter “FACMA 10”).

The absorption of CO₂ in a hydrocarbon fuel, such as diesel fuel, reduces the emission of soot from the engine as the fuel is used in the engine. It is believed that the absorbed CO₂ gas forms micro bubbles in the fuel droplets and helps create smaller droplets. It is necessary to maintain a concentration of CO₂ in the fuel in order to achieve a certain reduction of soot. If the con concentration drops, the soot increases. In order to keep a fixed level of CO₂ in the fuel, a mating concentration of CO₂ must be applied into the ullage of the fuel tank. Normally the use of the fuel will pull air into the ullage. The presence of air in the ullage of the CO₂-charged fuel will start to desorb CO₂ from the fuel until equilibrium is reached between the concentrations of the two phases of the CO₂ in the fuel tank. By supplying a mixture of CO₂ and air into the ullage, it is possible to prevent the desorption of CO₂ from the fuel.

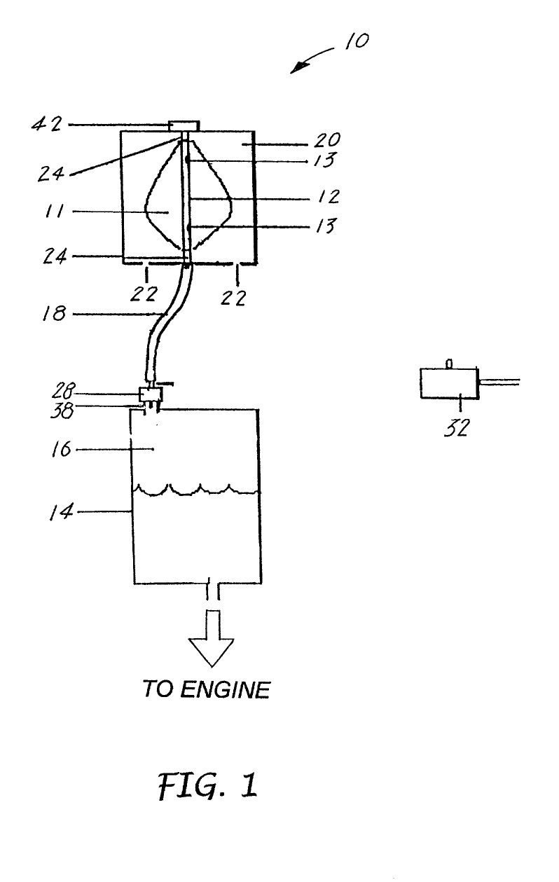

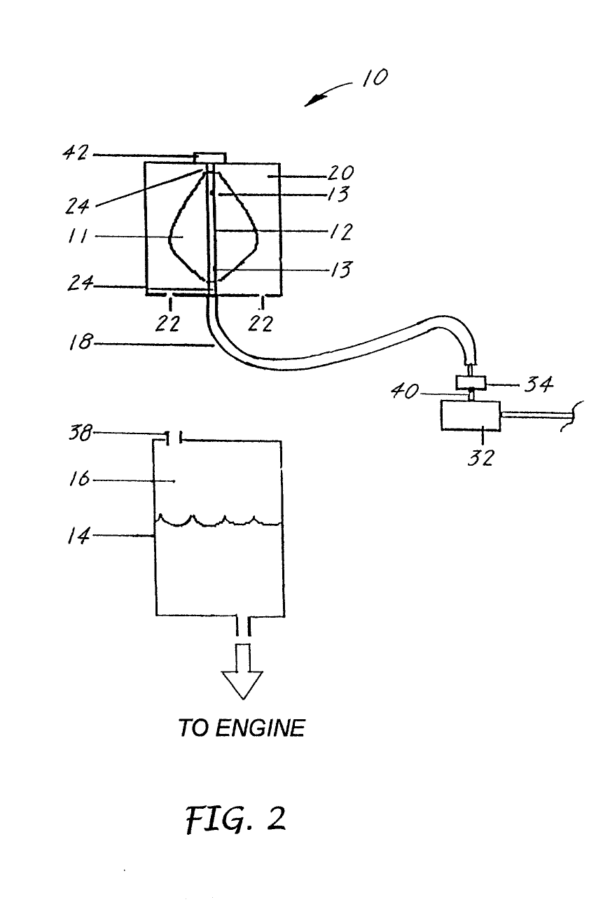

As shown in FIGS. 1 and 2, the FACMA 10 is comprised of three major elements: at least one gastight bag 11 containing a mixture of gas and air (“mixed gases”); at least one vehicle fuel tank 14 containing a gas-enriched fuel comprising a mixture of gas and a liquid hydrocarbon fuel, and having an ullage 16 located above the fuel; and a gas conduit 18 located between the gastight bag 11 and the ullage 16. As stated above, the FACMA 10 is designed to maintain the gas within the fuel at a predetermined concentration.

For disclosure and description within this patent application, the gas within the gastight bag 11 is comprised of carbon dioxide (CO₂), and the gas-enriched fuel is comprised of a mixture of CO₂ and diesel fuel. It is also believe that the FACMA 10 will be equally effective when used with other types of fuel, such as “Jet A” jet fuel.

The optimal ratio of the volume percent of the CO₂ gas in the ullage 16 of the fuel tank 14, to the volume of the CO₂ gas in the fuel is maintained at a value between 0.25 and 1.25.

The gastight bag 11, as shown in FIGS. 1 and 2, is comprised of a durable material having a flexibility which provides for numerous repeated cycles of bag pressurizations and decompressions. As also shown in FIGS. 1 and 2, the gastight bag 11 is enclosed within a protective enclosure 20 that surrounds and protects the bag 11 from damage. A gastight bag conduit 12 located within the gastight bag 11 has at least one port 13 for allowing the bi-directional flow of the mixed gases.

The gastight bag 11 within the protective enclosure 20 is dimensioned to hold a volume of gas not exceeding the vehicle fuel tank's volume. The enclosure 20 is preferably located within a vehicle void space or the enclosure 20 can be located within the body of an aerodynamic deflector above the cab of a truck-tractor.

The protective enclosure 20 has at least one air inlet 22 and a separate coupling means 24 for coupling the gastight bag 11 to the gas conduit 18, which is connected to the protective enclosure 20, as shown in FIGS. 1 and 2.

As also shown in FIGS. 1 and 2, the vehicle fuel tank 14 has a fuel tank cap 28 with the gas conduit 18 attached thereon to provide for the conveyance of the mixed gases in and out of the fuel tank 14.

A controllable gas source 32, as shown in FIGS. 1 and 2, is used to supply the desired gas mixture into the gastight bag 11. An additional coupling means 34, as shown in FIG. 2, is utilized to couple the opposite end of the gas conduit 18 to the gas source 32. Whenever the FACMA 10 is used on a truck-tractor, the driver will attach the additional coupling means 34 to the gas source 32 at the same time that the truck is being fuel or refueled, as shown in FIG. 2.

As shown in FIG. 1, the gas conduit 18 is attached to the fuel tank cap 28 and extends therethrough. The fuel tank cap 28 also has at least one seal 38 to prevent gas leakage and to promote the conveyance of the mixed gases through the gas conduit 18.

A normally-open gas-control valve 40, as shown in FIG. 2, is automatically closed when the gas conduit 18 is disconnected from the fuel tank 14, and is reconnected to the controllable gas source 32. Once the refueling is completed, the gas conduit 18 is disconnected from the gas source 32 and reconnected to the fuel tank 14.

In order to insure that the gastight bag 11 does not become over-pressurized, a pressure/vacuum relief valve 42, as shown in FIGS. 1 and 2, is located on the protective enclosure 20 and connected to the gas conduit 18.

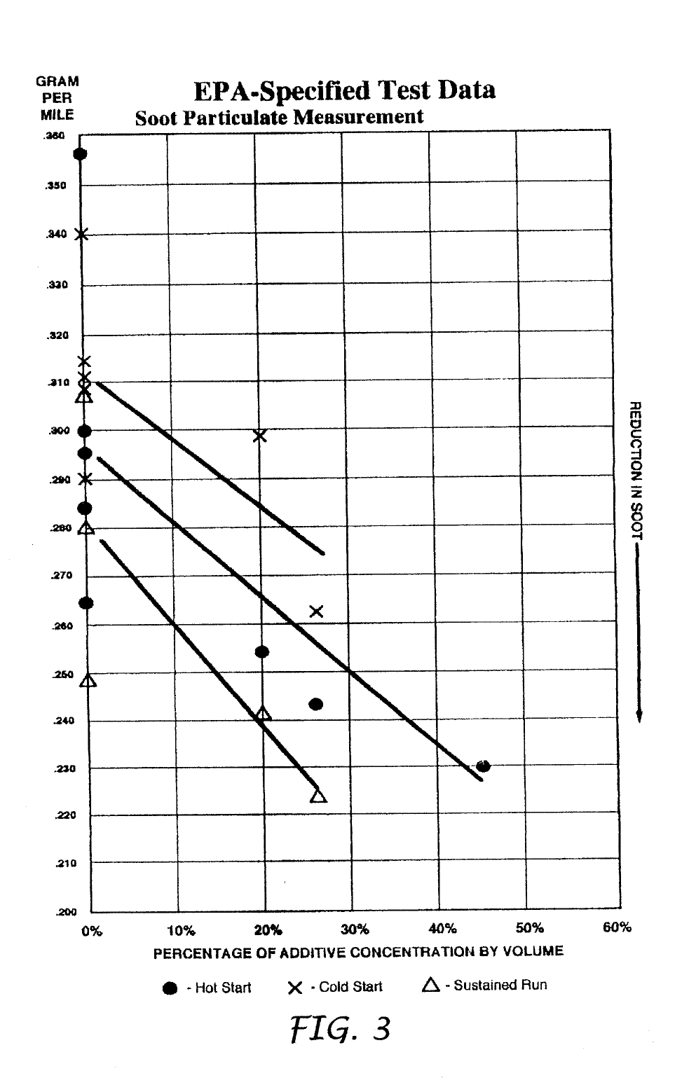

FIG. 3 shows the measured soot produced in a diesel engine with different concentrations of CO₂ in the diesel fuel. The testing was done to EPA requirements with three different test modes:

1. cold start (cool down overnight),

2. hot start (two minutes cool down) and

3. sustained run—hot start after ten minutes cool down and little acceleration during the test.

There is scatter in the data, but the general trend is a reduction in soot with increased CO₂ in the fuel.

While the invention has been described incomplete detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A fuel additive controlling and maintaining apparatus comprising:
a) at least one gastight bag containing a mixture of gas and air,
b) at least one vehicle fuel tank containing a gas-enriched fuel comprising a mixture of gas and a liquid hydrocarbon fuel, said at least one vehicle fuel tank having an ullage, located above the gas-enriched fuel, and
c) a gas conduit located between said at least one gastight bag and the ullage, wherein said apparatus maintains the gas within the fuel at a predetermined concentration.

2. The apparatus as specified in claim 1 wherein the gas in said at least one gastight bag is comprised of carbon dioxide (CO₂).

3. The apparatus as specified in claim 1 wherein the gas-enriched fuel is comprised of a mixture of CO₂ and diesel fuel.

4. The apparatus as specified in claim 3 wherein the optimal ratio of the volume percent of the CO₂ gas in the ullage of said at least one fuel tank to the volume of the CO₂ gas in the fuel in said at least one fuel tank is maintained at a value between 0.25 and 1.25.

5. The apparatus as specified in claim 1 wherein said at least one gastight bag is comprised of a durable material having a flexibility which provides for numerous repeated cycles of bag pressurizations and bag decompressions.

6. The apparatus as specified in claim 5 wherein said at least one gastight bag is enclosed within a protective enclosure that surrounds and protects said at least one gastight bag from damage.

7. The apparatus as specified in claim 6 wherein at least one gastight bag within said at least one protective enclosure is dimensioned to hold a volume of gas not exceeding the vehicle fuel tank volume.

8. The apparatus as specified in claim 6 wherein said gastight bag conduit located within said gastight bag further comprises at least one gas port which allows the bi-directional flow of the mixed gas.

9. The apparatus as specified in claim 7 wherein said protective enclosure has at least one air inlet and a separate coupling means for coupling said gastight bag to said gas conduit which is connected to said protective enclosure.

10. The apparatus as specified in claim 9 wherein said protective enclosure is located within a vehicle void space.

11. The apparatus as specified in claim 9 wherein said protective enclosure is located within the body of an aerodynamic deflector above the cab of a truck-tractor.

12. The apparatus as specified in claim 1 wherein said at least one vehicle fuel tank has at least one fuel tank cap with said gas conduit attached thereon to provide for the conveyance of said mixture of the mixed gases and in and out of said fuel tank.

13. The apparatus as specified in claim 9 further comprising an additional coupling means for coupling the opposite end of said gas conduit to a controllable gas source that can be used to provide the desired gas mixture into said gastight bag.

14. The apparatus as specified in claim 13 wherein said gas conduit is attached to the fuel tank cap and extends therethrough wherein said fuel tank cap has at least one seal to prevent gas leakage and to promote the conveyance of the mixed gases through said gas conduit.

15. The apparatus as specified in claim 13 further comprising a normally-open gas-control valve that is automatically closed when said gas conduit is disconnected from said fuel tank and reconnected to the controllable gas source, wherein after refueling, said gas conduit is disconnected from the controllable gas source and reconnected to the fuel tank.

16. The apparatus as specified in claim 7 further comprising a pressure/vacuum relief valve located on said protective enclosure and connected to the gas conduit.

17. A fuel additive controlling and maintaining apparatus for managing the bi-directional flow of mixed gases between at least one gastight bag and an ullage located above variable volumes of a gas-enriched liquid hydrocarbon fuel located in at least one vehicle fuel tank, wherein said apparatus stabilizes and maintains the concentration of said gases in the fuel during engine operation by replacing an increased fuel tank ullage volume with an equal amount of said mixed gases that are transferred from said at least one gastight bag.

18. The apparatus as specified in claim 17 wherein said at least one gastight bag is dimensioned to provide an expanded volume equal to the volume of said fuel tank.

19. The apparatus as specified in claim 18 wherein said gastight bag is located above said fuel tank and is enclosed within a protective enclosure.

20. The apparatus as specified in claim 19 wherein said gastight bag receives said mixed gases during refueling, wherein said mixed gases flow into the fuel tank ullage as the fuel is depleted by the engine to prevent desorption of said gases from the remaining fuel.
